(19) United States
(12) Patent Application Publication
(10) Pub. No.: US 2015/0262033 A1
(43) Pub. Date: Sep. 17, 2015

(54) METHOD AND TERMINAL DEVICE FOR CLUSTERING

(71) Applicant: Xiaomi Inc., Beijing (CN)

(72) Inventors: Zhijun Chen, Beijing (CN); Bo Zhang, Beijing (CN); Tao Zhang, Beijing (CN); Lin Wang, Beijing (CN)

(21) Appl. No.: 14/526,477

(22) Filed: Oct. 28, 2014

Related U.S. Application Data
(63) Continuation of application No. PCT/CN2014/082884, filed on Jul. 24, 2014.

(30) Foreign Application Priority Data
Mar. 14, 2014 (CN) 201410096608.9

(51) Int. Cl. G06K 9/62

(52) U.S. Cl. CPC G06K 9/6218; G06K 9/6215

(57) ABSTRACT

Embodiments of the present disclosure disclose a method and a terminal device for clustering. The method includes: obtaining a weighted distance between two classes according to a weight coefficient corresponding to an inter-object distance with respect to all classes to be combined; determining whether there are classes that can be combined according to the weighted distance between the two classes and a preset distance threshold; combining all of the classes that can be combined respectively, when the classes that can be combined exist; returning to perform the step of obtaining the weighted distance between the two classes until the number of the classes after combined is the same as the number of the classes before combined; and obtaining a clustering result. The present disclosure improves accuracy of the clustering result.

### CROSS REFERENCE TO RELATED APPLICATIONS

This application is a Continuation of International Application No. PCT/CN2014/082884, filed on Jul. 24, 2014, which is based upon and claims priority to Chinese Patent Application No. 201410096608.9, filed on Mar. 14, 2014, the entire contents of which are incorporated herein by reference.

### TECHNICAL FIELD

The present disclosure generally relates to the field of computer technology, and more particularly, to a method and a terminal device for clustering.

### BACKGROUND

Clustering is a process of dividing a set of physical or abstract objects into a plurality of classes composed of similar objects, i.e. a process of classifying the objects into different classes or clusters, such that the objects in the same class have a great similarity, and the objects from different classes have a great dissimilarity. A hierarchical method for clustering deconstructs the given objects hierarchically until a certain termination condition is satisfied. An agglomerative hierarchical method for clustering is a bottom-up strategy, it considers each object as an individual class at first, and then combines these classes into a bigger and bigger class until a certain termination condition is satisfied. Most of the hierarchical methods for clustering belong to this kind of strategy, only that the similarities for distinguishing classes are defined different.

For example, when the method for clustering is used for classifying pictures, the pictures that belong to the same person are classified into one class. A typical method for clustering only uses distances between the classes to measure a similarity between two faces. Distances between the respective objects make substantively the same contribution to the measurement of the similarity, such that the accuracy of a clustering result of this kind of method for clustering is rather low.

### SUMMARY

Accordingly, the present disclosure provides a method and a terminal device for clustering.

According to a first aspect of the embodiments of the present disclosure, there is provided a method for clustering, comprising: obtaining a weighted distance between two classes according to a weight coefficient corresponding to an inter-object distance with respect to all classes to be combined; determining whether there are classes that can be combined according to the weighted distance between the two classes and a preset distance threshold; combining all of the classes that can be combined respectively, when the classes that can be combined exist; returning to perform the step of obtaining the weighted distance between the two classes until the number of the classes after combined is the same as the number of the classes before combined; and obtaining a clustering result.

According to a second aspect of the embodiments of the present disclosure, there is provided a terminal device for clustering, comprises: a processor; and a memory for storing instructions executable by the processor, for performing: obtaining a weighted distance between two classes according to a weight coefficient corresponding to an inter-object distance with respect to all classes to be combined; determining whether there are classes that can be combined according to the weighted distance between the two classes and a preset distance threshold; combining all of the classes that can be combined respectively, when the classes that can be combined exist; returning to perform the step of obtaining the weighted distance between the two classes until the number of the classes after combined is the same as the number of the classes before combined; and obtaining a clustering result.

According to a third aspect of the embodiments of the present disclosure, there is provided a non-transitory readable storage medium comprising instructions, executable by a processor in a terminal device, for performing a method for clustering, the method comprising: obtaining a weighted distance between two classes according to a weight coefficient corresponding to an inter-object distance with respect to all classes to be combined; determining whether there are classes that can be combined according to the weighted distance between the two classes and a preset distance threshold; combining all of the classes that can be combined respectively, when the classes that can be combined exist; returning to perform the step of obtaining the weighted distance between the two classes until the number of the classes after combined is the same as the number of the classes before combined; and obtaining a clustering result.

According to a fourth aspect of the embodiments of the present disclosure, there is provided an apparatus for clustering, comprising: an acquiring unit configured for obtaining a weighted distance between two classes according to a weight coefficient corresponding to an inter-object distance with respect to all classes to be combined; a determining unit configured for determining whether there are classes that can be combined according to the weighted distance between the two classes and a preset distance threshold; a combining unit configured for combining all of the classes that can be combined respectively, when the classes that can be combined exist; returning to perform the step of obtaining the weighted distance between the two classes until the number of the classes after combined is the same as the number of the classes before combined; and obtaining a clustering result.

The technical solutions provided by the embodiments of the present disclosure may include, in part, the following advantageous effects: the method for clustering obtains the weighted distances between the classes according to the weight coefficient corresponding to the inter-object distance, the weight coefficient is determined according to the similarity between the two objects, i.e. the inter-object distance is weighted, and then the method combines the classes whose weighted distances meet a combining condition, and the method is not terminated until the number of the classes after combined is the same as the number of the classes before combined, and obtains the clustering result. Since the weighted distance is associated with the similarity between the two objects, different inter-object distances make different contributions, the greater the similarity is, and the bigger the corresponding contribution is. Thus, accuracy of the clustering result is increased.

It is to be understood that both the foregoing general description and the following detailed description are exemplary only and are not restrictive of the present disclosure.

### BRIEF DESCRIPTION OF THE DRAWINGS

The accompanying drawings, which are hereby incorporated in and constitute a part of this specification, illustrate embodiments consistent with the invention and, together with the description, serve to explain the principles of the invention.

FIG. 1 is a flow chart showing a method for clustering, according to an exemplary embodiment of the present disclosure;

FIG. 2 is a flow chart showing a step S110 in FIG. 1, according to an exemplary embodiment of the present disclosure;

FIG. 3 is a flow chart showing a step S111 in FIG. 2, according to an exemplary embodiment of the present disclosure;

FIG. 4 is a flow chart showing the obtaining of a weight coefficient, according to an exemplary embodiment of the present disclosure;

FIG. 5 is a diagram illustrating a clustering apparatus, according to an exemplary embodiment of the present disclosure;

FIG. 6 is a diagram illustrating another clustering apparatus, according to an exemplary embodiment of the present disclosure;

FIG. 7 is a block diagram illustrating a terminal device, according to an exemplary embodiment of the present disclosure; and

FIG. 8 is a block diagram illustrating a server, according to an exemplary embodiment of the present disclosure.

Specific embodiments in this disclosure have been shown by way of example in the foregoing drawings and will be described in detail hereinafter. The drawings are not intended to limit the scope of the inventive concepts of this disclosure in any manner. Rather, they are provided to illustrate the inventive concepts of the present disclosure to those skilled in the art with reference to particular embodiments.

### DETAILED DESCRIPTION

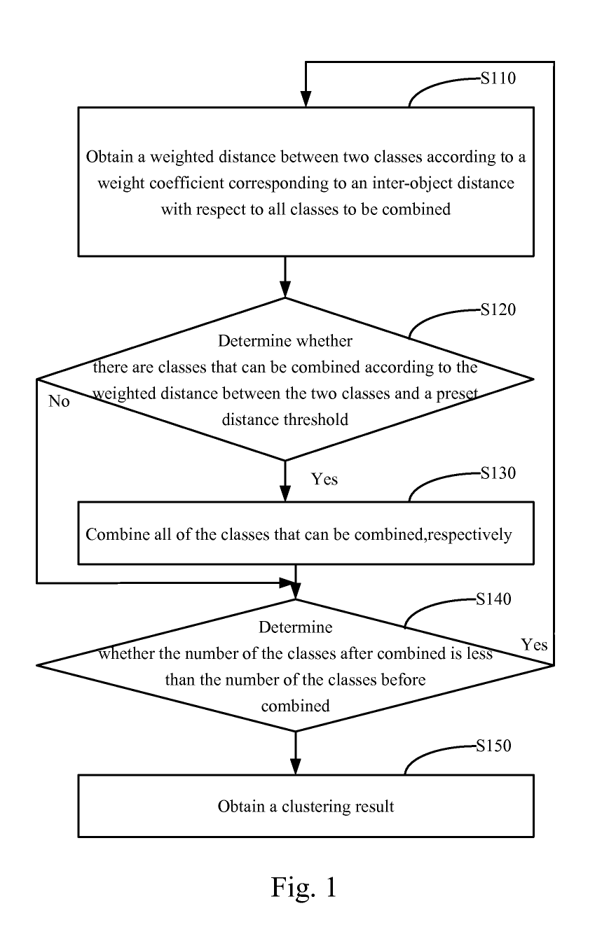

FIG. 1 is a flow chart showing a method for clustering, according to an exemplary embodiment. As shown in FIG. 1, the method for clustering may include the following steps S110, S120, S130 and S140.

In step S110, a weighted distance between two classes is obtained according to a weight coefficient corresponding to an inter-object distance, with respect to all classes to be combined. In some exemplary embodiments, the weight coefficient is determined according to a similarity between the objects.

It is assumed that the objects are human face images, and then the method for clustering provided by the present disclosure can gather the images that belong to the same person to form one cluster. Features in the face images are converted into a group of vectors, thus the inter-object distance is an inter-vector distance. Moreover, the method for clustering provided by the present disclosure may also be applicable for other data in addition to photos.

Before clustering, initialization is performed at first, each object is classified into one class, so each class only include one object. Then distances between the classes (namely inter-class distances) are calculated, i.e. distances (such as a cosine similarity, a Euclidean distance or the like) between each pair of objects are calculated.

The greater the inter-object similarity is, the larger the corresponding weight coefficient is. In contrast, the smaller the inter-object similarity is, the smaller the corresponding weight coefficient is. For example, the weight coefficient may be determined according to a probability of two objects corresponding to the inter-object distance being the same object; or the weight coefficient is obtained using a weighted kernel function w=f(d), wherein w is the weight coefficient, d is the inter-object distance. For example,

$$w = \frac{1}{{d}^{2}} ;$$

or the weight coefficient may also be obtained using a preset threshold, it is not to be enumerated here.

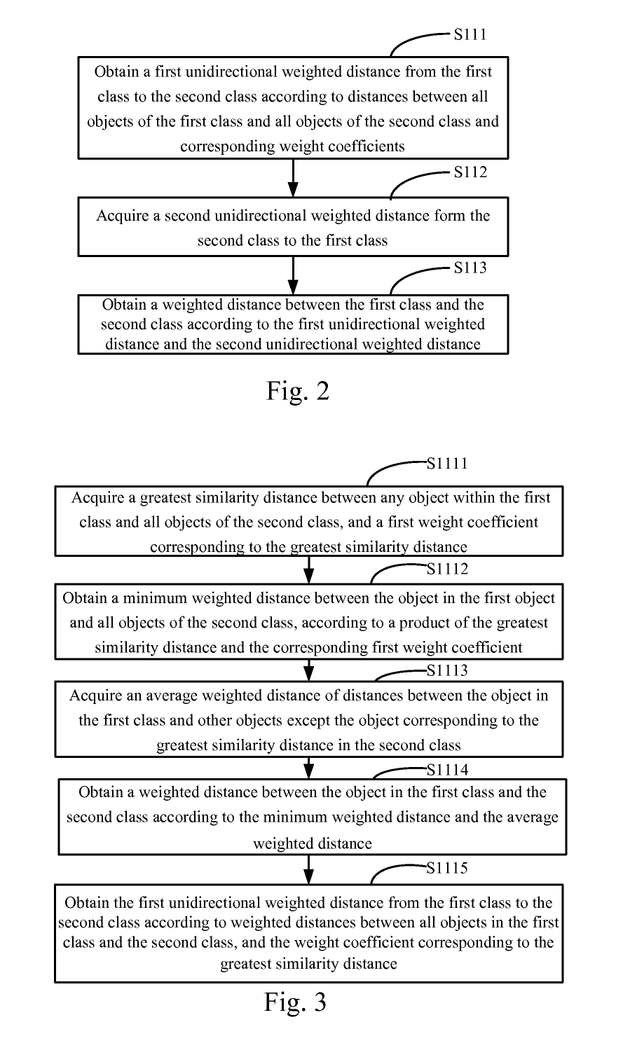

In one embodiment of the present disclosure, as shown in FIG. 2, the step S110 may further include the following sub-steps S111˜S113.

In step S111, a first unidirectional weighted distance from the first class to the second class is obtained according to distances between all objects of the first class and all objects of the second class and corresponding weight coefficients.

In one embodiment of the present disclosure, as shown in FIG. 3, the step S111 may include the following sub-steps S1111˜S1115.

In step S1111, a greatest similarity distance between any object within the first class and all objects within the second class, and a first weight coefficient corresponding to the greatest similarity distance are obtained.

It is assumed that the first class is labeled as A, the second class is labeled as B, the weighted distance between the class A and the class B is calculated, at first, distances d (Aᵢ, B) between any object Aᵢ in the class A and all objects in the class B are calculated, and the greatest similarity distance between the object Aᵢ and all objects in the class B is obtained. In the present embodiment, the cosine similarity is used. Thus, the inter-object similarity corresponding to a maximum cosine similarity dₘₐₓ(Aᵢ,B) is the largest.

Before explaining steps S1112-S115, the steps on how to calculate the weight coefficient based on the inter-object distance will be explained at first.

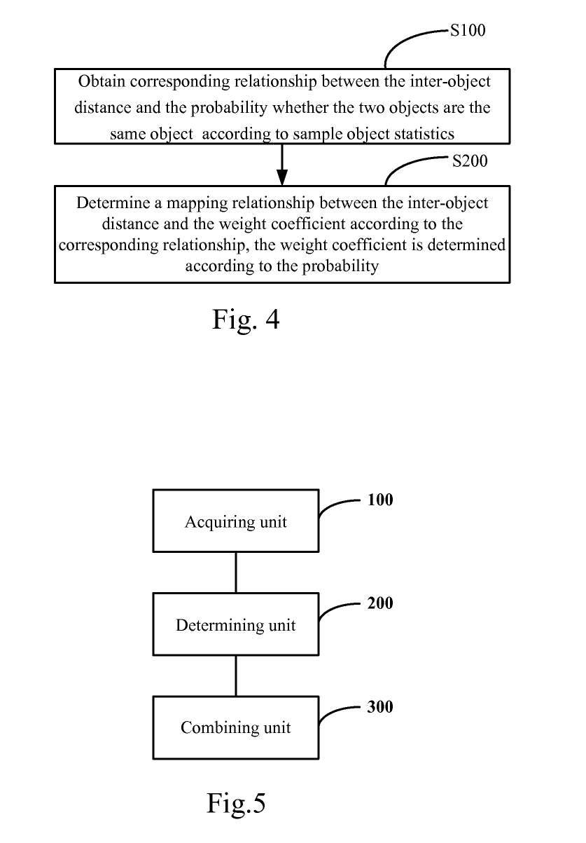

In an exemplary embodiment of the present disclosure, the weight coefficient may be obtained according to the probability of the two objects corresponding to the inter-object distance being the same object, as shown in FIG. 4, and it may include the following steps S100 and S200.

In step S100, a corresponding correlation between the inter-object distance and the probability of the two objects being the same object is obtained according to sample object statistics.

For example, in face recognition, a range of the cosine similarity cos θ of two face images is calculated to be [0, 1] according to high dimensional features. Moreover, according to a large amount of face image statistic data, it comes to a conclusion that when the cosine similarity is within a range of [0.45, 1], the probability that the two objects are the same person basically is 98%; when the cosine similarity is within a range of [0.35, 0.45], the probability that the two objects are the same person basically is 70%; when the cosine similarity is within a range of [0.25, 0.35], the probability that the two objects are the same person basically is 40%; when the cosine similarity is within a range of [0.15, 0.25], the probability that the two objects are the same person is basically 10%; and when the cosine similarity is within a range of [0, 0.15], the probability that the two objects are the same person basically is 0.1%.

According to the above statistic results, a relationship between the weight coefficient and the cosine similarity may be described using the following formula (1):

$$W ( d ) = \{ \begin{matrix}1 , if cos θ \geq 0.45 \\ 0.7 , if 0.35 \leq cos θ < 0.45 \\ 0.4 , if 0.25 \leq cos θ < 0.35 \\ 0.1 , if 0.15 \leq cos θ < 0.25 \\ 0.01 , if cos θ < 0.15\end{matrix} \qquad ( 1 )$$

The formula (1) represents a corresponding correlation between the cosine similarity and the probability of the two objects being the same person. Other types of distances may be concluded according to the correlation between the distances and the corresponding probabilities, it is not to be enumerated here.

In step S200, a mapping correlation between the inter-object distance and the weight coefficient is determined according to the corresponding correlation, and the weight coefficient is determined according to the probability.

The inter-object distance is obtained, and then it determines the inter-object distance is within which range according the formula (1). Finally, the mapping correlation between the inter-object distance and the weight coefficient is determined according to the formula (1). According to the above manner, an obtained weight coefficient corresponding to dₘₐₓ (Aᵢ, B) is W(dₘₐₓ (Aᵢ, B)).

After the greatest similarity distance and the first weight coefficient are obtained in step S1111, in step S1112, a minimum weighted distance (maximum cosine similarity) between the object in the first class and all objects of the second class is obtained according to a product of the greatest similarity distance and the corresponding first weight coefficient.

The minimum weighted distance φₘₐₓ (Aᵢ,B) between the object Aᵢ and the class B is obtained according to a formula (2):

φₘₐₓ(Aᵢ,B)=W(dₘₐₓ(Aᵢ,B))*dₘₐₓ(Aᵢ,B) (2)

In step S1113, an average weighted distance of distances between the object in the first class and other objects except the object corresponding to the greatest similarity distance in the second class is acquired.

It is assumed that the distance between the object Aᵢ in the class A and an object b in the class B is the greatest, the average weighted distance φ_{avg}(Aᵢ,B) between the object Aᵢ and the rest of the objects except the object b in the class B is acquired according to a formula (3):

$${ϕ}_{avg} ( {A}_{i} , B ) = \frac{{\sum }_{j ∈ B , j \neq b} W ( d ( {A}_{i} , {B}_{j} ) ) * d ( {A}_{i} {B}_{j} )}{{\sum }_{j ∈ B , j \neq b} W ( d ( {A}_{i} , {B}_{j} ) )} \qquad ( 3 )$$

In step S1114, a weighted distance between the object in the first class and the second class is obtained according to the minimum weighted distance and the average weighted distance.

From the minimum weighted distance φₘₐₓ(Aᵢ,B) and the average weighted distance φ_{avg}(Aᵢ,B) between the object Aᵢ and the class B, the weighted distance φ(Aᵢ,B) from the object Aᵢ to the class B is obtained according to a formula (4):

φ(Aᵢ,B)=φₘₐₓ(Aᵢ,B)+φ_{avg}(Aᵢ,B) (4)

In the above steps S1111 to S1114, the object Aᵢ may be any one of the objects in the first class. Therefore, by repeating the above steps S1111 to S1114, the weighted distances between each object in the first class and the second class can be obtained.

In step S1115, the first unidirectional weighted distance from the first class to the second class is obtained according to the weighted distances between all objects in the first class and the second class, and the weight coefficient corresponding to the greatest similarity distance.

The first unidirectional weighted distance S (A, B) between the class A and the class B is obtained according to a formula (5):

$$S ( A , B ) = \frac{{\sum }_{i ∈ A} ϕ ( {A}_{i} , B )}{{\sum }_{i ∈ A} W ( {d}_{ma x} ( {A}_{i} , B ) )} \qquad ( 5 )$$

In the formula (5), W(dₘₐₓ(Aᵢ,B)) refers to a weight coefficient corresponding to the maximum cosine similarity (the minimum distance) dₘₐₓ(Aᵢ, B) between the object Aᵢ in the class A and all objects in the class B.

After obtaining a first unidirectional weighted distance from the first class to the second class, in step S112, a second unidirectional weighted distance from the second class to the first class is is acquired.

The second unidirectional weighted distance S (B, A) from the class B to the class A is calculated, which is similar to the calculation of the first unidirectional weighted distance from the class A to the class B, it is not to be described repeatedly here.

In step S113, a weighted distance between the first class and the second class is obtained according to the first unidirectional weighted distance and the second unidirectional weighted distance.

The weighted distance H (A, B) between the class A and the class B is calculated according to a formula (6):

$$H ( A , B ) = \frac{S ( A , B ) + S ( B , A )}{2} \qquad ( 6 )$$

In step S120, it is determined whether there are classes that can be combined according to the weighted distance between the two classes and a preset distance threshold. When the classes that can be combined exist, step S130 is performed; and when the classes that can be combined do not exist, step S140 is performed.

The preset distance threshold may be set according to data types of different objects, and may be set according to types of the calculated inter-object distance (such as a cosine similarity, a Euclidean distance or the like). For example, when the objects are the face images, and the inter-object distance is the cosine similarity, then the distance threshold may be set to be 0.3˜0.35.

For the different types of inter-class distances used in the calculation of the weighted distance, the conditions for determining whether two classes can be combined are also different.

When the weighted distances of the classes are obtained according to the cosine similarities between the classes, it is determined whether or not the weighted distance between the two classes is smaller than the preset distance threshold, if the weighted distance between the two classes is not smaller than the preset distance threshold, it indicates that the similarity between the two classes is great and the two classes may be combined.

When the weighted distances between the classes are calculated from the Euclidean distance or other distances, it is determined whether or not the weighted distance between the two classes is greater than the preset distance threshold, if the weighted distance between the two classes is not greater than the preset distance threshold, it indicates that the similarity between the two classless is great and the two classes may be combined.

The weighted distance provided by the embodiments of the present disclosure is obtained by using the minimum weighted distance and the average weighted distance between the classes, in this way, not only the class that has more objects can be learned but also the class that has less objects can be considered wholly, which greatly accommodate to the characteristics of human face clustering. Thus, clustering using the weighted distance can increase the clustering accuracy.

In step S130, all of the classes that can be combined are combined respectively, when the two classes can be combined exists.

In step S140, the number of the classes after combined is less than the number of the classes before combined is determined. If the number of the classes after combined is less than the number of the classes before combined, the process returns to perform step S110, otherwise, the process goes forward to step S150.

When the number of the classes after combined is smaller than the number of the classes before combined, it returns to perform the step of obtaining the weighted distance between the two classes according to the weight coefficient corresponding to the inter-object distance with respect to all classes to be combined until the number of the classes after combined is the same as the number of the classes before combined, i.e. there is no more classes that can be combined, and a clustering result is obtained.

In step S150, a clustering result is obtained.

The similarity of the objects that are collected into one class is high, and the dissimilarity is low. Taking the face images as the objects, the face images that are collected into one class are the images of the same person.

In the method for clustering provided by the embodiments of the present disclosure, the weighted distance is between two classes is obtained according to a weight coefficient corresponding to an inter-object distance with respect to all classes to be combined; and, whether there are classes that can be combined is determined according to the weighted distance between the two classes and a preset distance threshold; then, all of the classes that can be combined respectively are combined, when the classes that can be combined exist; and then a clustering result is obtained by returning to perform the step of obtaining the weighted distance between the two classes until the number of the classes after combined is the same as the number of the classes before combined. Since the weighted distance is associated with the similarity of the two objects, different object-between distances make different contributions, the greater the similarity is, the bigger the corresponding contribution is. Thus, accuracy of the clustering result is increased.

FIG. 5 is a diagram illustrating a clustering apparatus, according to an exemplary embodiment. Referring to FIG. 5, the device includes an acquiring unit 100, a determining unit 200 and a combining unit 300.

The acquiring unit 100 is configured to obtain a weighted distance between two classes according to a weight coefficient corresponding to an inter-object distance with respect to all classes to be combined. The weight coefficient is determined according to a similarity between two objects corresponding to the inter-object distance.

The acquiring unit 100 may include a first acquiring sub-unit, a second acquiring sub-unit, a third acquiring sub-unit and a fourth acquiring sub-unit.

The first acquiring sub-unit is configured to acquire a greatest similarity distance between any object within the first class and all objects within the second class, and a first weight coefficient corresponding to the greatest similarity distance.

The second acquiring sub-unit is configured to obtain a first unidirectional weighted distance from the first class to the second class according to the greatest similarity distance and the corresponding first weight coefficient, with respect to all objects of the first class.

In one embodiment of the present disclosure, the second acquiring sub-unit may include a fifth acquiring sub-unit, a sixth acquiring sub-unit, a seventh acquiring sub-unit, an eighth acquiring sub-unit and a ninth acquiring sub-unit.

The fifth acquiring sub-unit is configured to acquire a greatest similarity distance between any object within the first class and all objects of the second class, and a first weight coefficient corresponding to the greatest similarity distance.

The sixth acquiring sub-unit is configured to obtain a minimum weighted distance between the object in the first object and all objects of the second class, according to a product of the greatest similarity distance and the corresponding first weight coefficient.

The seventh acquiring sub-unit is configured to acquire an average weighted distance of distances between the object in the first class and other objects except the object corresponding to the greatest similarity distance in the second class.

The eighth acquiring sub-unit is configured to obtain a weighted distance between the object in the first class and the second class according to the minimum weighted distance and the average weighted distance.

The ninth acquiring sub-unit is configured to obtain the first unidirectional weighted distance from the first class to the second class according to the weighted distances between all objects in the first class and the second class, and the weight coefficients corresponding to the weighted distances.

The third acquiring sub-unit is configured to acquire a second unidirectional weighted distance from the second class to the first class.

The fourth acquiring sub-unit is configured to obtain a weighted distance between the first class and the second class according to the first unidirectional weighted distance and the second unidirectional weighted distance.

The determining unit 200 is configured to determine whether the two classes can be combined according to the weighted distance between the two classes and a preset distance threshold.

The combining unit 300 is configured to respectively combine all classes that can be combined when the two classes can be combined, and to make the acquiring unit perform the step of obtaining the weighted distance between the two classes according to the weight coefficient corresponding to the inter-object distance with respect to all classes to be combined until the number of the classes after combined is the same as the number of the classes before combine, i.e. the classes that can be combined don't exist, to obtain a clustering result.

In the clustering apparatus provided by the embodiments of the present disclosure, the weighted distance is between two classes is obtained by the acquiring unit according to a weight coefficient corresponding to an inter-object distance with respect to all classes to be combined. Moreover, the determining unit determines whether there are classes that can be combined according to the weighted distance between the two classes and a preset distance threshold. Then the combining unit combines all of the classes whose weighted distance meet the combining condition until the number of the classes after combined is the same as the number of the classes before combined, and a clustering result is obtained. Since the weighted distance is associated with the similarity of the two objects, different object-between distances make different contributions, the greater the similarity is, the bigger the corresponding contribution is. Thus, accuracy of the clustering result is increased.

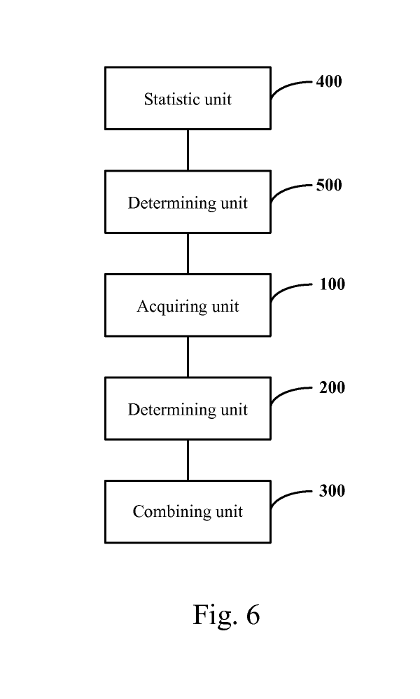

FIG. 6 is a diagram illustrating another clustering apparatus, according to an exemplary embodiment. Referring to FIG. 6, the device includes a statistic unit 400, a determining unit 500, an acquiring unit 100, a determining unit 200 and a combining unit 300. Wherein the units whose names and reference numbers are the same as those of the embodiment shown in FIG. 5 have the same function, it is not to be described repeatedly here.

The statistic unit 400 is configured to obtain a corresponding correlation between an inter-object distance and a probability of two objects being the same object according to sample object statistics.

The determining unit 500 is configured to determine a mapping correlation between the inter-object distance and a weight coefficient according to the corresponding correlation, and the weight coefficient is determined according to the probability.

The determining unit may include a examining sub-unit and a determining sub-unit.

The examining sub-unit is configured to examine the corresponding correlation to obtain the probability of the two objects corresponding to the inter-object distance being the same person.

The determining sub-unit is configured to determine that the probability is the weight coefficient corresponding to the inter-object distance.

The acquiring unit 300 connected with the determining unit 500 is configured to obtain a weighted distance between two classes according to the weight coefficient corresponding to the inter-object distance.

In the clustering apparatus provided by the embodiments of the present disclosure, firstly the corresponding correlation between the inter-object distance and the probability of the two objects being the same object is obtained according to a great number of sample objects so as to determine the corresponding weight coefficient, and then the weighted distance between the classes is obtained, the classes that can be combined are determined according to the weighted distance, and the classes that can be combined are combined until the number of the classes after combined and the number of the classes before combined are not changed, thus obtaining a clustering result. Since the weighted distance is associated with the probability whether the two objects are the same object, it can consider the situations that the probability whether the two objects are the same object changes as the distance between the two objects changes, thereby different object-between distances make different contributions, the greater the probability value is, the bigger the corresponding contribution is. Thus, the method for clustering can increase accuracy of the clustering result.

With respect to the devices in the above embodiments, the specific manners for performing operations for individual modules therein have been described in detail in the embodiments regarding the method for clustering, which will not be elaborated herein.

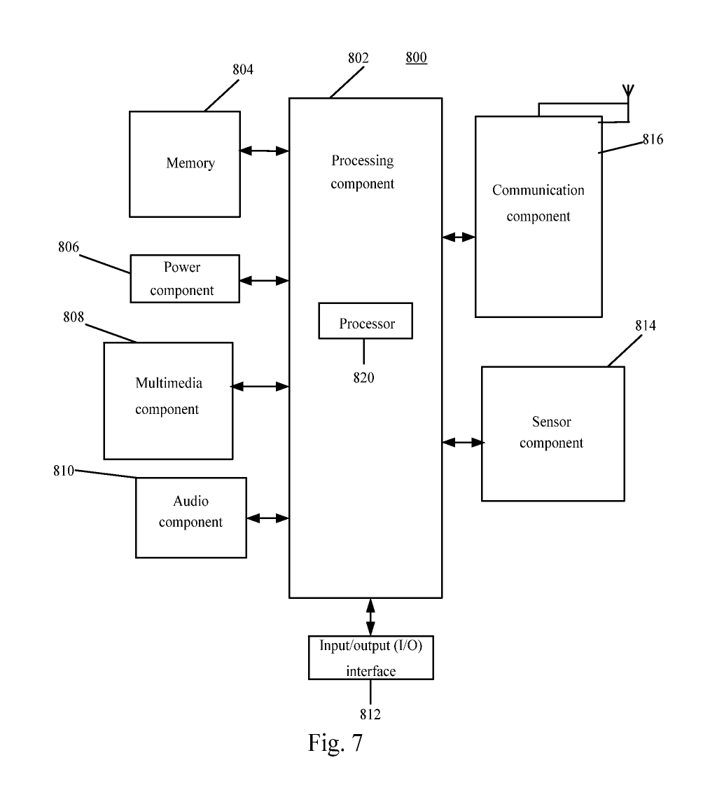

FIG. 7 is a block diagram illustrating a terminal device 800 for clustering, according to an exemplary embodiment. For example, the terminal device 800 may be a mobile phone, a computer, a digital broadcast terminal, a messaging device, a gaming console, a tablet, a medical device, exercise equipment, a personal digital assistant and the like.

Referring to FIG. 7, the terminal device 800 may include one or more of the following components: a processing component 802, a memory 804, a power component 806, a multimedia component 808, an audio component 810, an input/output (I/O) interface 812, a sensor component 814, and a communication component 816.

The processing component 802 usually controls overall operations of the terminal device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any application or method operated on the terminal device 800, contact data, phonebook data, messages, pictures, videos, etc. The memory 804 may be implemented using any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal device 800. The power component 806 may include a power management system, one or more power sources, and other components associated with the generation, management, and distribution of power in the terminal device 800.

The multimedia component 808 includes a screen providing an output interface between the terminal device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 808 includes a front camera and/or a rear camera. The front camera and/or the rear camera may receive an external multimedia datum while the terminal device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, a button, and the like. The button may include, but not limited to, a home button, a volume button, a starting button, and a locking button.

The sensor component 814 includes one or more sensors to provide status assessments of various aspects of the terminal device 800. For instance, the sensor component 814 may detect an open/closed status of the terminal device 800, relative positioning of components, e.g., the display and the keyboard, of the terminal device 800, a change in position of the terminal device 800 or a component of the terminal device 800, a presence or absence of user contact with the terminal device 800, an orientation or an acceleration/deceleration of the terminal device 800, and a change in temperature of the terminal device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal device 800 and other devices. The terminal device 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 804, executable by the processor 820 in the terminal device 800, for performing the above-described methods. For example, the non-transitory computer-readable storage medium may be a ROM, a random access memory (RAM), a CD-ROM, a magnetic tape, a floppy disc, an optical data storage device, and the like.

A non-transitory computer readable storage medium, when instructions in the storage medium are executed by the processor of the terminal device, the terminal device can execute a method for clustering, the method includes: obtaining a weighted distance between two classes according to a weight coefficient corresponding to an inter-object distance with respect to all classes to be combined; determining whether there are classes that can be combined according to the weighted distance between the two classes and a preset distance threshold; combining all of the classes that can be combined respectively, when the classes that can be combined exist; returning to perform the step of obtaining the weighted distance between the two classes until the number of the classes after combined is the same as the number of the classes before combined; and obtaining a clustering result.

Alternatively, the method further includes: obtaining a corresponding correlation between the inter-object distance and a probability of the two objects being the same object according to sample object statistics; and determining a mapping correlation between the inter-object distance and the weight coefficient according to the corresponding correlation, the weight coefficient being determined according to the probability.

Alternatively, determining the mapping correlation between the inter-object distance and the weight coefficient according to the corresponding correlation has the following manner: examining the corresponding correlation to obtain the probability of the two objects corresponding to the inter-object distance being the same object; and determining that the probability is the weight coefficient corresponding to the inter-object distance.

Alternatively, the weighted distance is a weighted distance between a first class and a second class; and the obtaining the weighted distance between the two classes according to the weight coefficient corresponding to the inter-object distance with respect to all classes to be combined has the following manner: obtaining a first unidirectional weighted distance from the first class to the second class according to distances between all objects of the first class and all objects of the second class and corresponding weight coefficients; acquiring a second unidirectional weighted distance form the second class to the first class; and obtaining a weighted distance between the first class and the second class according to the first unidirectional weighted distance and the second unidirectional weighted distance.

Alternatively, obtaining the first unidirectional weighted distance from the first class to the second class according to the distances between all objects of the first class and all objects of the second class and the corresponding weight coefficients has the following manner: acquiring a greatest similarity distance between any object within the first class and all objects of the second class that has the greatest similarity, and a first weight coefficient corresponding to the greatest similarity distance; obtaining a minimum weighted distance between the object in the first object and all objects of the second class, according to a product of the greatest similarity distance and the corresponding first weight coefficient; acquiring an average weighted distance of distances between the object in the first class and other objects except the object corresponding to the greatest similarity distance in the second class; obtaining a weighted distance between the object in the first class and the second class according to the minimum weighted distance and the average weighted distance; and obtaining the first unidirectional weighted distance from the first class to the second class according to the weighted distances between all objects in the first class and the second class, and the weight coefficients corresponding to the weighted distances.

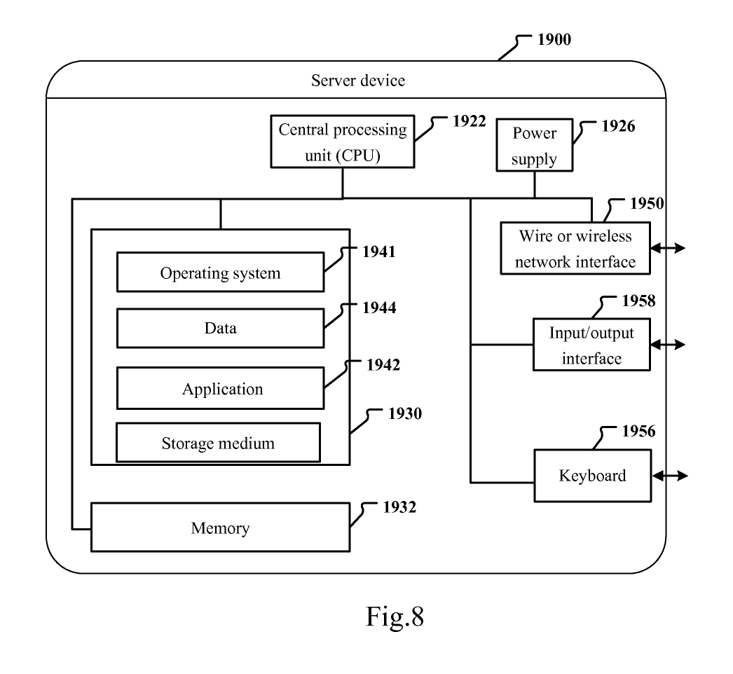

FIG. 8 is a structure diagram of a server in the embodiments of the present disclosure. For example, a server 1900 may very significantly due to different configurations and performances, and may include one or more central processing units (CPU) 1922 (such as one or more processors) and a memory 1932, one or more storage mediums 1930 (such as one or more mass-storage devices) for storing applications 1942 or data 1944. The memory 1932 and the storage medium 1930 may be may be a transient or a persistent storage. Programs stored in the storage medium 1930 may include one or more modules (not shown in the drawings), and each module may include a series of instruction operations in a terminal device. Further, the CPU 1922 may be provided to communicate with the storage medium 1930, and execute on the server 1900 a series of instruction operations in the storage medium 1930.

The server 1900 may also includes one or more power supplies 1926, one or more wire or wireless network interfaces 1950, one or more input/output interfaces 1958, one or more keyboards 1956, and/or one or more operating systems 1941, such as Windows Server™, Mac OS X™, Unix™, Linux™, FreeBSD™, or the like.

In exemplary embodiments, there is also provided a non-transitory computer readable storage medium including instructions, such as included in the memory 1932 or storage medium 1930, which may be executed by the processor 1922 in the terminal device so as to perform the above-described methods. For example, the non-transitory computer-readable storage medium may be a ROM, a random access memory (RAM), a CD-ROM, a magnetic tape, a floppy disc, an optical data storage device, and the like.

A non-transitory computer readable storage medium, when instructions in the storage medium are executed by the processor of the terminal device, the terminal device can execute a method for clustering, the method includes: obtaining a weighted distance between two classes according to a weight coefficient corresponding to an inter-object distance with respect to all classes to be combined; determining whether there are classes that can be combined according to the weighted distance between the two classes and a preset distance threshold; combining all of the classes that can be combined respectively, when the classes that can be combined exist; returning to perform the step of obtaining the weighted distance between the two classes until the number of the classes after combined is the same as the number of the classes before combined; and obtaining a clustering result.

Alternatively, the method further includes: obtaining a corresponding correlation between the inter-object distance and a probability of the two objects are the same object according to sample object statistics; and determining a mapping correlation between the inter-object distance and the weight coefficient according to the corresponding correlation, the weight coefficient being determined according to the probability.

Alternatively, the determining the mapping correlation between the inter-object distance and the weight coefficient according to the corresponding correlation has the following manner: examining the corresponding correlation to obtain the probability of the two objects corresponding to the inter-object distance being the same object; and determining that the probability is the weight coefficient corresponding to the inter-object distance.

Alternatively, the weighted distance is a weighted distance between a first class and a second class; and obtaining the weighted distance between the two classes according to the weight coefficient corresponding to the inter-object distance with respect to 11 classes to be combined has the following manner: obtaining a first unidirectional weighted distance from the first class to the second class according to distances between all objects of the first class and all objects of the second class and corresponding weight coefficients; acquiring a second unidirectional weighted distance form the second class to the first class; and obtaining a weighted distance between the first class and the second class according to the first unidirectional weighted distance and the second unidirectional weighted distance.

Alternatively, the obtaining the first unidirectional weighted distance from the first class to the second class according to the distances between all objects of the first class and all objects of the second class and the corresponding weight coefficients has the following manner: acquiring a greatest similarity distance between any object within the first class and all objects of the second class that has the greatest similarity, and a first weight coefficient corresponding to the greatest similarity distance; obtaining a minimum weighted distance between the object in the first object and all objects of the second class, according to a product of the greatest similarity distance and the corresponding first weight coefficient; acquiring an average weighted distance of distances between the object in the first class and other objects except the object corresponding to the greatest similarity distance in the second class; obtaining a weighted distance between the object in the first class and the second class according to the minimum weighted distance and the average weighted distance; and obtaining the first unidirectional weighted distance from the first class to the second class according to the weighted distances between all objects in the first class and the second class, and the weight coefficients corresponding to the weighted distances.

It should be understood that the present invention is not limited to the precise structure that is described above and shown in the drawings, and may be modified and changed without departing from the scope. The scope of the present invention is only limited by the appended claims.

It is explained that, in the context, relationship terms such as “first” and “second” are only used to distinguish one entity or operation from another entity or operation, it is not necessary to imply or require that these entities or operations have the actual relationship or sequence. Moreover, terms “including”, “comprising” or any other variant mean to cover non-exclusive including, so that a process, a method, an article or a device including a series of elements not only includes those elements but also includes other elements that are not clearly listed, or further includes elements naturally possessed by the process, the method, the article, or the device. Without more limits, elements defined by the phase “including a . . . ” don't exclude the fact that the process, the method, the article or the device including the elements further includes other same elements.

The above mentioned are only detailed embodiments of the present disclosure, and those skilled in the art can understand or implement the present disclosure. Various modifications to these embodiments are obvious for those skilled in the art. General concepts defined in the context may be carried out in other embodiments without departing from the purpose or scope of the present disclosure. Thus, the present disclosure will not be limited to these embodiments shown herein, and the present disclosure is intended to be conformed to the broadest scope consistent with the principles and novel features disclosed herein.

What is claimed is:

1. A method for clustering, comprising:
obtaining a weighted distance between two classes according to a weight coefficient corresponding to an inter-object distance with respect to all classes to be combined;
determining whether there are classes that can be combined according to the weighted distance between the two classes and a preset distance threshold;
combining all of the classes that can be combined respectively, when the classes that can be combined exist;
returning to perform the step of obtaining the weighted distance between the two classes until the number of the classes after combined is the same as the number of the classes before combined; and
obtaining a clustering result.

2. The method according to claim 1, wherein the weight coefficient is determined according to a similarity between the objects.

3. The method according to claim 1, wherein the method further comprises:
obtaining a corresponding correlation between the inter-object distance and a probability of the two objects being the same object according to sample object statistics; and
determining a mapping correlation between the inter-object distance and the weight coefficient according to the corresponding correlation.

4. The method according to claim 3, wherein the weight coefficient is determined according to the probability of the two objects being the same object.

5. The method according to claim 3, wherein determining the mapping correlation between the inter-object distance and the weight coefficient according to the corresponding correlation comprises:
examining the corresponding correlation to obtain the probability of the two objects corresponding to the inter-object distance being the same object; and
determining that the probability is the weight coefficient corresponding to the inter-object distance.

6. The method according to claim 1, wherein the weighted distance is a weighted distance between a first class and a second class, and obtaining the weighted distance between the two classes comprises:
obtaining a first unidirectional weighted distance from the first class to the second class according to distances between all objects of the first class and all objects of the second class and corresponding weight coefficients;
acquiring a second unidirectional weighted distance form the second class to the first class; and
obtaining a weighted distance between the first class and the second class according to the first unidirectional weighted distance and the second unidirectional weighted distance.

7. The method according to claim 3, wherein the weighted distance is a weighted distance between a first class and a second class, and obtaining the weighted distance between the two classes comprises:
obtaining a first unidirectional weighted distance from the first class to the second class according to distances between all objects of the first class and all objects of the second class and corresponding weight coefficients;
acquiring a second unidirectional weighted distance form the second class to the first class; and
obtaining a weighted distance between the first class and the second class according to the first unidirectional weighted distance and the second unidirectional weighted distance.

8. The method according to claim 6, wherein obtaining the first unidirectional weighted distance comprises:
acquiring a greatest similarity distance between any object within the first class and all objects of the second class that has the greatest similarity, and a first weight coefficient corresponding to the greatest similarity distance;
obtaining a minimum weighted distance between the object in the first object and all objects of the second class, according to a product of the greatest similarity distance and the corresponding first weight coefficient;
acquiring an average weighted distance of distances between the object in the first class and other objects except the object corresponding to the greatest similarity distance in the second class;
obtaining a weighted distance between the object in the first class and the second class according to the minimum weighted distance and the average weighted distance; and
obtaining the first unidirectional weighted distance from the first class to the second class according to the weighted distances between all objects in the first class and the second class, and the weight coefficients corresponding to the weighted distances.

9. The method according to claim 7, wherein obtaining the first unidirectional weighted distance comprises:
acquiring a greatest similarity distance between any object within the first class and all objects of the second class that has the greatest similarity, and a first weight coefficient corresponding to the greatest similarity distance;
obtaining a minimum weighted distance between the object in the first object and all objects of the second class, according to a product of the greatest similarity distance and the corresponding first weight coefficient;
acquiring an average weighted distance of distances between the object in the first class and other objects except the object corresponding to the greatest similarity distance in the second class;
obtaining a weighted distance between the object in the first class and the second class according to the minimum weighted distance and the average weighted distance; and
obtaining the first unidirectional weighted distance from the first class to the second class according to the weighted distances between all objects in the first class and the second class, and the weight coefficients corresponding to the weighted distances.

10. A terminal device for clustering, comprises:
a processor; and
a memory for storing instructions executable by the processor, for performing:
obtaining a weighted distance between two classes according to a weight coefficient corresponding to an inter-object distance with respect to all classes to be combined;
determining whether there are classes that can be combined according to the weighted distance between the two classes and a preset distance threshold;
combining all of the classes that can be combined respectively, when the classes that can be combined exist;
returning to perform the step of obtaining the weighted distance between the two classes until the number of the classes after combined is the same as the number of the classes before combined; and
obtaining a clustering result.

11. The terminal device according to claim 10, wherein the weight coefficient is determined according to a similarity between the objects.

12. The terminal device according to claim 10, wherein the processor is also configured for performing:
obtaining a corresponding correlation between the inter-object distance and a probability of the two objects being the same object according to sample object statistics; and
determining a mapping correlation between the inter-object distance and the weight coefficient according to the corresponding correlation.

13. The terminal device according to claim 12, wherein the weight coefficient is determined according to the probability of the two objects being the same object.

14. The terminal device according to claim 12, wherein determining the mapping correlation between the inter-object distance and the weight coefficient according to the corresponding correlation comprises:
examining the corresponding correlation to obtain the probability of the two objects corresponding to the inter-object distance being the same object; and
determining that the probability is the weight coefficient corresponding to the inter-object distance.

15. The terminal device according to claim 10, wherein the weighted distance is a weighted distance between a first class and a second class, and obtaining the weighted distance between the two classes comprises:
obtaining a first unidirectional weighted distance from the first class to the second class according to distances between all objects of the first class and all objects of the second class and corresponding weight coefficients;
acquiring a second unidirectional weighted distance form the second class to the first class; and
obtaining a weighted distance between the first class and the second class according to the first unidirectional weighted distance and the second unidirectional weighted distance.

16. The terminal device according to claim 12, wherein the weighted distance is a weighted distance between a first class and a second class, and obtaining the weighted distance between the two classes comprises:
obtaining a first unidirectional weighted distance from the first class to the second class according to distances between all objects of the first class and all objects of the second class and corresponding weight coefficients;
acquiring a second unidirectional weighted distance form the second class to the first class; and
obtaining a weighted distance between the first class and the second class according to the first unidirectional weighted distance and the second unidirectional weighted distance.

17. The terminal device according to claim 15, wherein obtaining the first unidirectional weighted distance comprises:
acquiring a greatest similarity distance between any object within the first class and all objects of the second class that has the greatest similarity, and a first weight coefficient corresponding to the greatest similarity distance;
obtaining a minimum weighted distance between the object in the first object and all objects of the second class, according to a product of the greatest similarity distance and the corresponding first weight coefficient;
acquiring an average weighted distance of distances between the object in the first class and other objects except the object corresponding to the greatest similarity distance in the second class;
obtaining a weighted distance between the object in the first class and the second class according to the minimum weighted distance and the average weighted distance; and
obtaining the first unidirectional weighted distance from the first class to the second class according to the weighted distances between all objects in the first class and the second class, and the weight coefficients corresponding to the weighted distances.

18. The terminal device according to claim 16, wherein obtaining the first unidirectional weighted distance comprises:
acquiring a greatest similarity distance between any object within the first class and all objects of the second class that has the greatest similarity, and a first weight coefficient corresponding to the greatest similarity distance;
obtaining a minimum weighted distance between the object in the first object and all objects of the second class, according to a product of the greatest similarity distance and the corresponding first weight coefficient;
acquiring an average weighted distance of distances between the object in the first class and other objects except the object corresponding to the greatest similarity distance in the second class;
obtaining a weighted distance between the object in the first class and the second class according to the minimum weighted distance and the average weighted distance; and
obtaining the first unidirectional weighted distance from the first class to the second class according to the weighted distances between all objects in the first class and the second class, and the weight coefficients corresponding to the weighted distances.

19. A non-transitory readable storage medium comprising instructions, executable by a processor in a terminal device, for performing a method for clustering, the method comprising:
obtaining a weighted distance between two classes according to a weight coefficient corresponding to an inter-object distance with respect to all classes to be combined;
determining whether there are classes that can be combined according to the weighted distance between the two classes and a preset distance threshold;
combining all of the classes that can be combined respectively, when the classes that can be combined exist;
returning to perform the step of obtaining the weighted distance between the two classes until the number of the classes after combined is the same as the number of the classes before combined; and
obtaining a clustering result.
